(19) United States
(12) Patent Application Publication
(10) Pub. No.: US 2025/0238385 A1
(43) Pub. Date: Jul. 24, 2025

(54) DATA PROCESSING METHOD AND SERVER

(71) Applicant: Lenovo (Beijing) Limited, Beijing (CN)

(72) Inventors: Lianguo WANG, Beijing (CN); Huan YAN, Beijing (CN)

(21) Appl. No.: 19/031,010

(22) Filed: Jan. 17, 2025

(30) Foreign Application Priority Data
Jan. 24, 2024 (CN) 202410102390.7

(51) Int. Cl. G06F 13/362

(52) U.S. Cl. CPC G06F 13/3625

(57) ABSTRACT

A data processing method includes establishing a connection identifier in response to a connection request from a client when the connection identifier does not exist; establishing survival information of the connection identifier, and periodically updating the survival information based on a survival state of the connection identifier, the survival information being used to indicate whether the connection identifier is alive; when the connection identifier exists, obtaining the survival information of the connection identifier to determine whether the connection identifier has timed out in response to the connection request from the client; and when the connection identifier times out, clearing the connection identifier and sending a connection failure message to the client.

### CROSS-REFERENCES TO RELATED APPLICATION

This application claims priority to Chinese Patent Application No. 202410102390.7 filed on Jan. 24, 2024, the entire content of which is incorporated herein by reference.

### FIELD OF TECHNOLOGY

The present disclosure relates to the technical field of data processing and, more specifically, to a data processing method and a server.

### BACKGROUND

In computer systems, there is a file sharing issue between virtual machines and Windows operating systems. Generally, a server message block (SMB) communication protocol is used for file sharing. The SMB protocol works in a client-server manner, with the client making requests and the server responding.

In this case, if an error such as a process crash occurs during communication through the SMB protocol, the Windows operating system may directly report an error when trying to open the shared file again. In some cases, it may take minutes to several hours before the Windows operating system can reopen the file, and the user experience is poor.

### SUMMARY

One aspect of this disclosure provides a data processing method. The method includes establishing a connection identifier in response to a connection request from a client when the connection identifier does not exist; establishing survival information of the connection identifier, and periodically updating the survival information based on a survival state of the connection identifier, the survival information being used to indicate whether the connection identifier is alive; when the connection identifier exists, obtaining the survival information of the connection identifier to determine whether the connection identifier has timed out in response to the connection request from the client; and when the connection identifier times out, clearing the connection identifier and sending a connection failure message to the client.

Another aspect of this disclosure provides a data processing method that is applied to a client. The method includes sending a connection request to a server to establish a connection identifier on the server when the connection identifier does not exist on the server. The server is configured to establish survival information of the connection identifier and periodically update the survival information based on a survival state of the connection identifier. The survival information is used to indicate whether the connection identifier is alive. The method further includes, when the connection request is not responded to normally and the connection request is disconnected, sending the connection request to the server again to cause the server to obtain the survival information of the connection identifier to determine whether the connection identifier has timed out. The server is configured to clear the connection identifier and send a connection failure message to the client when the connection identifier times out. The method further includes, in response to the connection failure message, sending the connection request to the server again to establish the connection with the client.

Another aspect of the present disclosure provides a server. The server includes an establishing module, an updating module, an acquisition module and a clearing module. The establishing module is configured to establish a connection identifier in response to a connection request from a client when the connection identifier does not exist. The updating module is configured to establish survival information of the connection identifier and periodically update the survival information based on a survival state of the connection identifier. The survival information is used to indicate whether the connection identifier is alive. The acquisition module is configured to obtain the survival information of the connection identifier to determine whether the connection identifier has timed out in response to the connection request from the client when the connection identifier exists. The clearing module is configured to clear the connection identifier when the connection identifier times out and send a connection failure message to the client.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a schematic diagram of an application scenario of a data process method and a server according to some embodiments of the present disclosure.

FIG. 2 is a flowchart of the data processing method applied to the server according to some embodiments of the present disclosure.

FIG. 3 is a flowchart of the data processing method applied to the server according to some embodiments of the present disclosure.

FIG. 4 is a flowchart of clearing a timeout connection identifier in the data processing method according to some embodiments of the present disclosure.

FIG. 5 is a schematic maintenance diagram of survival information in the data processing method according to some embodiments of the present disclosure.

FIG. 6 is a flowchart of the data processing method applied to a client according to some embodiments of the present disclosure.

FIG. 7 is a flowchart of the data processing method applied to the client according to some embodiments of the present disclosure.

FIG. 8 is a schematic structural diagram of the server according to some embodiments of the present disclosure.

FIG. 9 is a schematic structural diagram of the client according to some embodiments of the present disclosure.

FIG. 10 is a schematic structural diagram of an exemplary electronic device according to some embodiments of the present disclosure.

### DETAILED DESCRIPTION

Hereinafter, embodiments of the present disclosure will be described with reference to the accompanying drawings. It should be understood, however, that these descriptions are merely for illustrative purposes and are not intended to limit the scope of the disclosure. In addition, in the following paragraphs, descriptions of well-known structures and techniques are omitted to avoid unnecessarily obscuring the concepts of the present disclosure.

The terminology used herein is for the purpose of describing particular embodiments only, and is not intended to limit the disclosure. The terms “a”, “an” and “the” and the like, as used herein, should also include the meaning of “a plurality,” “a variety of” unless the context clearly dictates otherwise. Furthermore, the terms “include,” “include,” and the like, as used herein, indicate the presence of stated features, steps, operations, and/or components, but do not preclude the presence or addition of one or more other features, steps, operations, or components.

All terms (including technical and scientific terms) used herein have the meaning as commonly understood by one of ordinary skill in the art, unless otherwise defined. It should be noted that terms used herein should be interpreted as having a meaning that is consistent with the context of the present descriptions and should not be interpreted in an idealized or overly stereotypical manner.

In relation to the drawings, a few block diagrams and/or flow charts are illustrated. It should be understood that certain blocks in the block diagrams and/or the flow charts, or combinations thereof may be implemented by computer program instructions. These computer program instructions may be provided to a processor of a general-purpose computer, special-purpose computer, or any other programmable data processing apparatus such that the instructions, when executed by the processor, enable the processor to implement the functions/operations illustrated in these block diagrams and/or flow charts.

Accordingly, the techniques of the present disclosure may be implemented in the form of hardware and/or software (including firmware, microcode, etc.). In addition, embodiments of the present disclosure may be in the form of computer program instructions stored in a computer readable medium. And the computer program instructions may be used by or in connection with an instruction execution system, such as a computer processor. In the context of the present disclosure, the computer readable medium may refer to any medium that can contain, store, communicate, propagate, or transport the instructions. For example, the computer readable media may include but are not limited to electrical, magnetic, optical, electromagnetic, infrared, or semiconductor systems, devices, devices, or transmission medium. Specific examples of the computer readable medium may include a magnetic storage device such as a magnetic tape or a hard disk (HDD); an optical storage device such as a compact disc (CD-ROM); a memory such as a random-access memory (RAM) or a flash memory; and/or wireless/wired communication link.

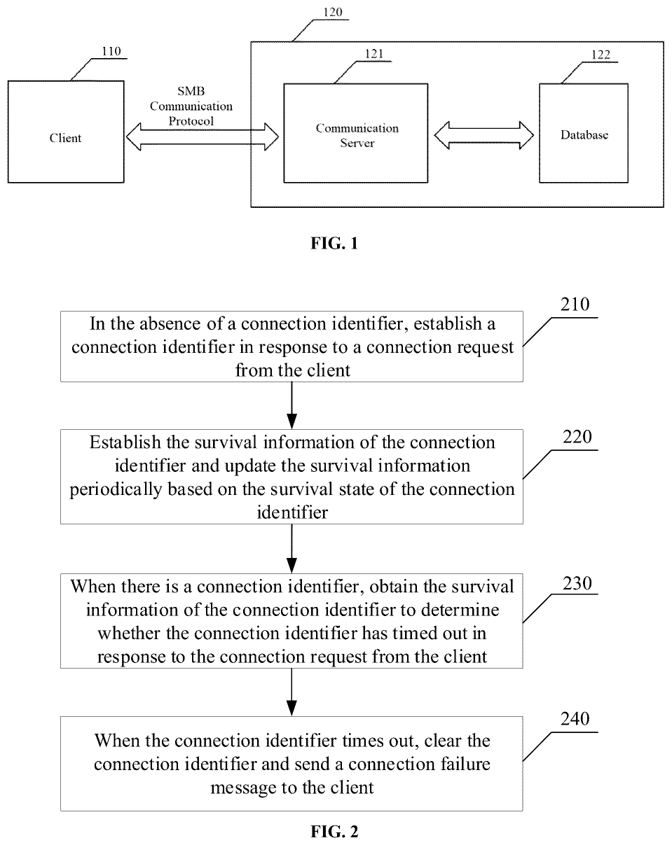

FIG. 1 is a schematic diagram of an application scenario of a data process method and a server according to some embodiments of the present disclosure. It should be noted that FIG. 1 is only an example of a scenario in which the embodiments of the present disclosure can be applied, to help those skilled in the art understand the technical content of the present disclosure, but does not mean that the embodiments of the present disclosure cannot be used in other devices, systems, environments or scenarios.

More specifically, as shown in FIG. 1, the application scenario of the data processing method and server based on the embodiments of the present disclosure includes a client 110 and a server 120. The client 110 is connected to the server 120 for communication, and the connection manner may be, for example, a wired connection, a wireless communication link connection, or a fiber optic cable connection.

The communication method between the client 110 and the server 120 may include communication activities through the server message block (SMB) communication protocol to realize file sharing between the client and the server.

The server 120 includes a communication server 121 and a database 122. The communication server 121 can be configured to establish an SMB communication connection with a client. For each client applying for a connection, the communication server 121 can generate a smbd subprocess corresponding to the client using, for example, the smbd main process. The smbd subprocess can be used to handle and interact with the corresponding client, including file and print services, as well as authentication and authorization functions. While the client 110 and the communication server 121 are connected, the smbd subprocess may generate a connection identifier and store it in the communication server 121 to indicate that the connection is effective. After the connection is disconnected normally, the smbd main process may clear the corresponding connection identifier.

The database 122 is connected to the communication server 121 for communication. The database 122 may be configured to store the survival information generated by the communication server 121 for each client. The survival information can be used to indicate whether the connection identifier is alive.

It should be understood that the number of clients and servers in FIG. 1 is an example. Based on actual needs, there may be any number of clients and servers, and the database may also be arranged on any electronic device that can communicate with the client and the server.

The connection identifier may be created on the server when the client and server successfully establish a connection. In addition, the connection identifier may be cleared on the server after the client and server successfully complete the communication task and disconnect. In some embodiments, if a failure occurs after the connection is established and the connection identifier is created, causing the client and server to disconnect without completing the communication task, at this time, the connection identifier in the server cannot be successfully cleared. When the client applies for reconnection, an error will appear or it will take a long time to reconnect.

For example, when the client and server communicate through the SMB communication protocol. The client requests to open a file on the server, the server will create a corresponding smbd subprocess to handle the communication task with the client. At the same time, a connection identifier corresponding to the file and the client will be generated on the server, for example, a persistent handle. After the communication task between the client and the server is incomplete and the smbd process crashes, the client will apply for reconnection to establish the connection and open the file, but at this time, the connection identifier already exists in the server. When the connection identifier is not cleared, the server will return a file unavailable identifier, such as NT_STATUS_FILE_NOT_AVAILABLE. The client using Windows 7 will not recognize the NT_STATUS_FILE_NOT_AVAILABLE returned by the server and will directly report an error. The client using Windows 10 will repeatedly try to open the file after receiving NT_STATUS_FILE_NOT_AVAILABLE until the connection identifier is cleared and then it will be successfully opened.

For example, when the communication task between the client and the server is incomplete and the server fails, for example, when the server uses SMB communication protocol to communicate, the server crashes. At this time, the server has no chance to notify the cleanup process to clean up the connection identifier, and the connection identifier will always be saved in the server. In this case, when the client requests to open the file again, the server's cleanup timer will be started to clean the connection identifier. This cleaning method will take minutes or even hours to complete. During this period, every request by the client to open the file will be rejected.

Based on the above example, embodiments of the present disclosure provide a data processing method which can be applied to a server. The data processing method includes, in the absence of a connection identifier, establishing a connection identifier in response to a client's connection request; establishing survival information of the connection identifier and periodically update the survival information based on a survival state of the connection identifier, the survival information being used to indicate whether the connection identifier is alive; when the connection identifier exists, in response to the client's connection request, obtaining the survival information of the connection identifier to determine whether the connection identifier has timed out; when the connection identifier times out, clearing the connection identifier and sending a connection failure message to the client.

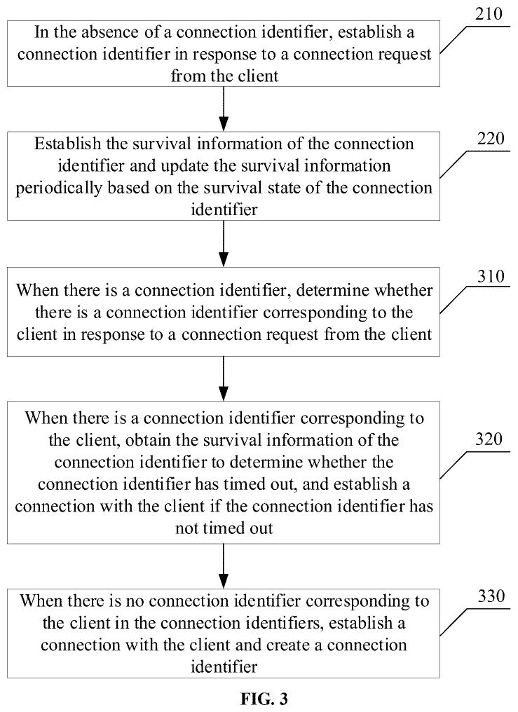

Based on the scenario described in FIG. 1, the data processing method provided in the embodiments of the present disclosure will be described in detail with reference to FIG. 2 to FIG. 6.

FIG. 2 is a flowchart of the data processing method applied to the server according to some embodiments of the present disclosure. As shown in FIG. 2, the processes in the data processing method can be performed in the server. The method will be described in detail below.

210, in the absence of a connection identifier, establishing a connection identifier in response to a connection request from the client.

In the embodiments of the present disclosure, if there is no connection identifier in the server, it may indicate that the client has not accessed the file and the file can be opened normally by the client. After receiving the client's connection request, a connection identifier corresponding to the client and the file that client wants to open can be established. The connection identifier may indicate that the client has established a connection with the server and is trying to access and open the file or is accessing the file. The connection identifier can be stored in the server. For one client and one file, only one connection identifier can exist at the same time. There may be multiple different connection identifiers for the same client and different files, and there may also be multiple different connection identifiers for the same file and different clients.

In the embodiments of the present disclosure, the connection identifier may include a first part and a second part. The first part may represent the client corresponding to the connection identifier, and the second part may represent the file corresponding to the connection identifier.

220, establishing the survival information of the connection identifier and updating the survival information periodically based on the survival state of the connection identifier, the survival information being used to indicate whether the connection identifier is alive.

In the embodiments of the present disclosure, after the connection identifier is established, the survival information of the connection identifier may be established and saved in the communication server 121 described above, and the survival information may be used to indicate whether the connection identifier is alive. The survival information stored in the communication server 121 may be maintained by a heartbeat mechanism, which periodically updates the survival information based on the survival state of the connection identifier. More specifically, updating the survival information may include updating the current survival timestamp of the survival information, adding or deleting the survival information, etc.

230, when there is a connection identifier, obtaining the survival information of the connection identifier to determine whether the connection identifier has timed out in response to the connection request from the client.

In the embodiments of the present disclosure, after receiving the connection request from the client, whether there is a connection identifier may be determined first. If there is no connection identifier, the processes at 210 and 220 can be performed to establish a normal connection to respond to the normal connection request of the client, and the file that the client needs to open can be opened to realize file sharing.

In the embodiments of the present disclosure, if there is no connection identifier, it may indicate that the last connection between the current client and the server failed to exit successfully, and the connection identifier corresponding to the client is still saved in the server. At this time, after receiving another connection request from the client to open the file, the survival information of the connection identifier can be obtained from the database, and the whether the connection identifier has timed out can be determined based on the survival information.

In the embodiments of the present disclosure, the survival information can be used to determine whether the connection identifier has timed out. If the survival information of the connection identifier is not successfully obtained, the connection identifier may be determined as timed out. Alternatively, when the survival information of the connection identifier is obtained and the survival information times out, the connection identifier may be determined as timed out.

More specifically, whether the corresponding survival information exists in the database can be determined based on the connection identifier. If the corresponding survival information does not exist in the database, then the connection identifier must have timed out. If the corresponding survival information exists in the data, whether the connection identifier has timed out may be determined based on the survival information.

For example, the connection identifier can be a structured object, which includes two parts. The first part may be the client information and the second part may be in the file information. The corresponding survival information may be created based on the connection identifier, and the survival information may include first sub-survival information and second sub-survival information. The first sub-survival information may represent the client and file corresponding to the connection identifier, and the second sub-survival information may represent the survival timestamp, at which the connection identifier corresponding to the survival information must not have timed out. Based on the survival timestamp in the survival information and the current timestamp, whether the connection identifier corresponding to the survival information has timed out can be calculated.

240, when the connection identifier times out, clearing the connection identifier and sending a connection failure message to the client.

In some embodiments, when the connection identifier is obtained and the connection identifier times out, the connection identifier may be cleared and a connection failure message may be sent to the client. For example, a cleanup timer may be set to clear the connection identifier after a certain time, or a cleanup process may be directly executed to clear the timed-out connection identifier. In other embodiments, if the survival information of the connection identifier is obtained and it is determined that the connection identifier has timed out based on the obtained survival information, the corresponding survival information in the database may also be cleared at the same time.

In the embodiments of the present disclosure, in response to the connection request initiated by the client, the connection identifier may be determined to be timed out based on the survival information, and the connection identifier may be cleared if the connection identifier times out. Then in the next reconnection request initiated by the client, the server no longer has the timed-out connection identifier corresponding to the client. Therefore, in the event of a normal connection failure, after the failure is repaired, the client only needs one or two reconnections to successfully connect and access the file. For example, when the client reconnects for the first time and it is founded that the connection identifier has timed out, in the response to the connection request, the timed-out connection identifier will be deleted, and the next reconnection request can be responded to normally. It only takes two times to reconnect, and the response is fast.

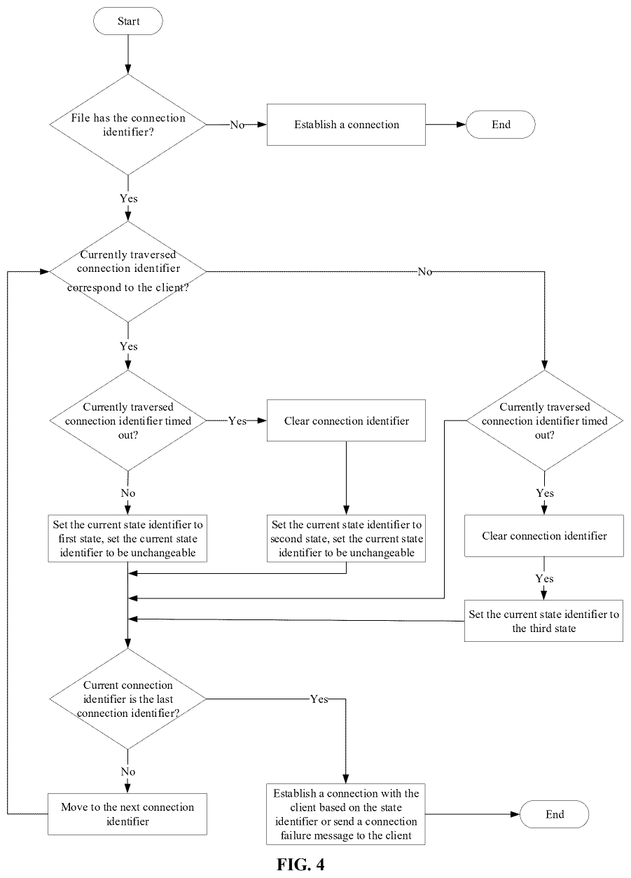

FIG. 3 is a flowchart of the data processing method applied to the server according to some embodiments of the present disclosure.

As shown in FIG. 3, after the process at 220, the data processing method may further include processes 310 to 330.

310, when there is a connection identifier, determining whether there is a connection identifier corresponding to the client in response to a connection request from the client.

In some embodiments, since there may be more than one client, there may be more than one connection identifier corresponding to the same file. In this case, whether the file has a connection identifier needs to be determined first. If the number of connection identifiers corresponding to the file is zero, it may indicate that the file can be accessed normally by the client. After receiving the connection request from the client, the connection can be directly established to share the file. If the number of connection identifiers corresponding to the file is not zero, then whether there is a connection identifier corresponding to the client sending the connection request in all connection identifiers may need to be determined.

320, when there is a connection identifier corresponding to the client, obtaining the survival information of the connection identifier to determine whether the connection identifier has timed out, and establishing a connection with the client if the connection identifier has not timed out. More specifically, where there is a connection identifier corresponding to the client, a connection success identifier may be returned to the client to cause the client to perform the next operation, such as opening a shred file.

330, when there is no connection identifier corresponding to the client in the connection identifiers, establishing a connection with the client and creating a connection identifier.

In some embodiments, when determining whether a file exists in the connection identifiers corresponding to the client, each connection identifier of the file may be traversed in a loop. Based on the first part of the connection identifier that is, the part representing the client corresponding to the connection identifier, whether the connection identifier is the connection identifier corresponding to the client can be determined in turn. When a connection identifier corresponding to the client sending the connection request does not exist in all the connection identifiers, a connection with the client can be established, and a connection request corresponding to the client and the file to be opened by the client can be created.

In some embodiments, when the file has multiple connection identifiers, the connection identifier of the corresponding client may be searched from the file. If the file does not include any client connection identifier, the client and server may directly connect normally. If a server failure occurs, after the failure is repaired, the client initiates a reconnection request. At this time, if the file includes the connection identifier corresponding to the client and the connection identifier has not timed out, the client may only need to initiate a reconnection to establish the connection.

FIG. 4 is a flowchart of clearing a timeout connection identifier in the data processing method according to some embodiments of the present disclosure.

As shown in FIG. 4, based on the embodiment shown in FIG. 3, the data processing method can be improved by adding a determination loop.

In some embodiments, the process of clearing the timeout connection identifier in the data processing method may include processes 410 to 430.

410, determining whether the file has a connection identifier, if there is no connection identifier, connecting the client and the server normally.

420, when there are connection identifiers in the file, executing a loop body for each connection identifier of the file in loop until all connection identifiers are traversed to clear invalid connection identifiers from all connection identifiers. In some embodiments, the loop body may include processes 421 to 425.

421, determining whether the currently traversed connection identifier corresponds to the client. More specifically, the identifier stored in the currently traversed connection identifier may be determined. The identifier may be used to determine whether the connection identifier is the connection identifier corresponding to the client that is currently sending the connection request.

422, when the currently traversed connection identifier corresponds to the client, setting the current state identifier to a first state and setting the current state identifier to be unchangeable, the first state indicating that a connection can be established with the client without creating a connection identifier.

In other embodiments, the process at 422 may include: when the currently traversed connection identifier corresponds to the client, determining whether the current connection identifier has timed out. If the current connection identifier has not timed out, setting the current state identifier to the first state and setting the current state identifier to be unchangeable. If the current connection identifier has timed out, setting the current state to a second state and the current state identifier to be unchangeable, and clearing the timed-out connection identifier. In some embodiments, the second state may indicate that a connection cannot be established with the client.

423, when the currently traversed connection identifier does not correspond to the client, determining whether the current connection identifier has timed out. More specifically, the survival information corresponding to the connection identifier may be obtained to determine whether the connection identifier has timed out. The determination process may be similar to the process at 230, which will be not described in detail here.

424, when the current connection identifier has timed out, clearing the timed-out connection identifier and setting the current state identifier to a third state, the third state indicating that a connection can be established with the client and a connection identifier needs to be created.

425, when the current connection identifier has not timed out, setting the current state identifier to the third state, calculating the timeout time of the current connection identifier, and setting a cleanup timer based on the timeout time to clean up the current connection identifier after the timeout time is reached.

430, establishing a connection with the client or sending a connection failure message to the client based on the state identifier. More specifically, when the state identifier is the first state, a connection may be established with the client; when the state identifier is the second state, the client's connection may be rejected and a connection failure message may be sent to the client; when the state identifier is the third state, a connection may be established with the client and a connection identifier may be created.

In this embodiment, the process at 310 in the embodiment shown in FIG. 3 is improved. In each determination process, whether all traversed connection identifiers have timed out can be determined. If the connection identifiers are timed out, the connection identifiers can be cleared. If the connection identifiers have not timed out, a timer can be set to clear the connection identifiers after they are timed out. In this way, after any client initiates a reconnection request, the server will clean up all the saved connection identifiers. For example, if the connection identifier of client 1 has timed out, after client 2 initiates a reconnection request, the server's response to client 2's reconnection request will also clear the timed-out connection identifier of client 1. In this way, the cleaning efficiency of the connection identifier is greatly improved, thereby increasing the reconnection speed.

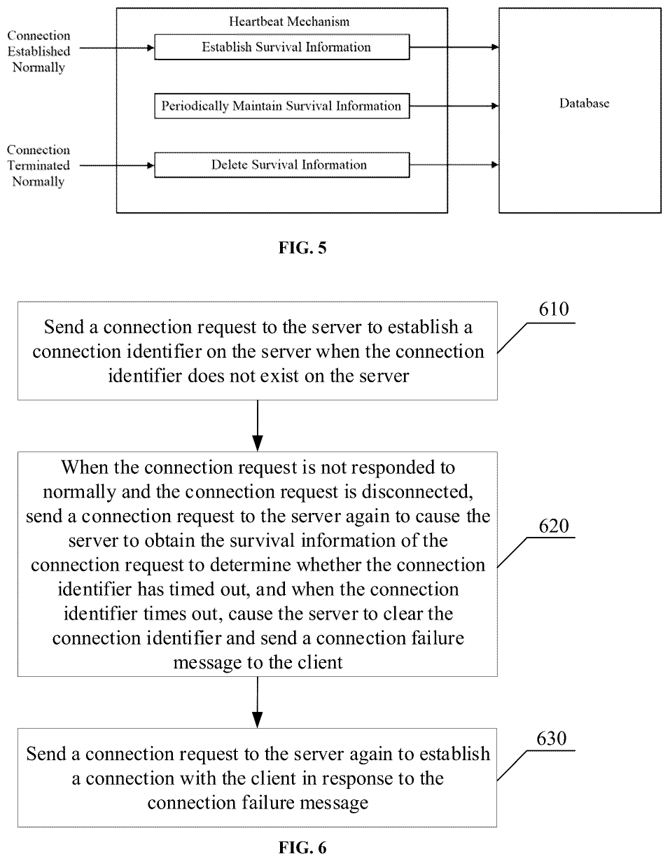

FIG. 5 is a schematic maintenance diagram of survival information in the data processing method according to some embodiments of the present disclosure.

In some embodiments, as shown in FIG. 5, the saved survival information is maintained through a heartbeat process.

In some embodiments, the heartbeat process may receive a first update signal and update the survival information based on the first update signal. More specifically, after receiving the first update signal, the heartbeat process may find the survival information corresponding to the first update signal, and update the survival information timestamp in the survival information based on the timestamp of the received first update signal.

In combination with a frequent scenario and a frequent data processing method, an example of updating all specific information is provided below.

For example, when a client establishes a new connection with a server, the smbd main process will create a smbd subprocess to provide services to the client. When the subprocess is created, the server will create a connection identifier for this connection and the survival information corresponding to the connection identifier. At this time the smbd subprocess sends the first update signal and the current time to the heartbeat process. After the sending is completed, the smbd subprocess will set a timer to send the first update signal to the heartbeat process again after a preset period of time. This time is the heartbeat interval.

After the heartbeat process receives the first update signal and the current time, it searches the database for the corresponding survival information and changes the survival timestamp in the survival information to the received current time.

In some embodiments, the heartbeat process may receive a first destruction signal and destroy the corresponding survival information based on the first destruction signal. More specifically, after receiving the first destruction signal, the heartbeat process searches for the survival information corresponding to the first destruction signal, updates the survival information, and sets a timer to clear the survival information after a specific time.

In combination of the scenario and the data processing method described above, a specific example of destroying the survival information is provided below.

For example, when the connection between the client and the server is disconnected normally, the smbd subprocess will exit. When exiting, the first destruction signal will be sent to the heartbeat process to inform that the survival information needs to be destroyed. After receiving the first destruction signal, the heartbeat process first searches the database for the survival information corresponding to the first destruction signal, updates the survival information timestamp of the survival information for the last time based on the current time, and sets a timer to clear the survival time after a specific time. The specific time here may be set as the maximum response time for client connection requests.

In some embodiments, the heartbeat process may periodically clean up invalid survival information in the database. More specifically, a timer can be set to periodically call the cleanup function or start a cleanup subprocess to traverse each survival information in the data, identify the survival information that has timed out, and clean it up.

In combination of the scenario and the data processing method described above, a specific example of periodically cleaning up invalid survival information in the database is provided below.

For example, the heartbeat process will set a timer and call the cleanup function at regular intervals. The cleanup function is configured to traverse each survival information in the database. If the survival timestamp in the survival information plus the maximum response time of the client connection request and the heartbeat interval is not greater than the current timestamp, then the survival information is determined to be invalid, the connection identifier corresponding to the survival information has timed out, and it is marked as invalid data. After traversing all the survival information, all the survival information marked as invalid data can be cleaned up.

In some embodiments, the heartbeat mechanism may also determine the current server before creating the cleanup subprocess. If the current server is in a fault recovery state, no cleanup activity may be performed. If the current server is in normal working condition, the server can be cleaned up and exited after the cleanup is completed.

In some embodiments, to prevent the cleanup subprocess from getting stuck, a timer may be set after the cleanup subprocess is created. When the preset time is exceeded, the cleanup subprocess can be terminated.

Generally, the connection identifier does not include time information, and modifying the connection identifier to add time information will increase the calculation cost of the connection identifier. The connection identifier is often used in the communication between the client and the server. Directly modifying the connection identifier will not only affect the communication efficiency, but also easily cause problems. For example, when the connection identifier is being used, the time information is maintained, causing communication conflicts. In the embodiments of the present disclosure, the heartbeat mechanism is used to maintain the survival information of the connection identifier, and the survival information is used to further determine the timeout of the connection identifier, thereby avoiding the problem and making the maintenance cost simple and efficient.

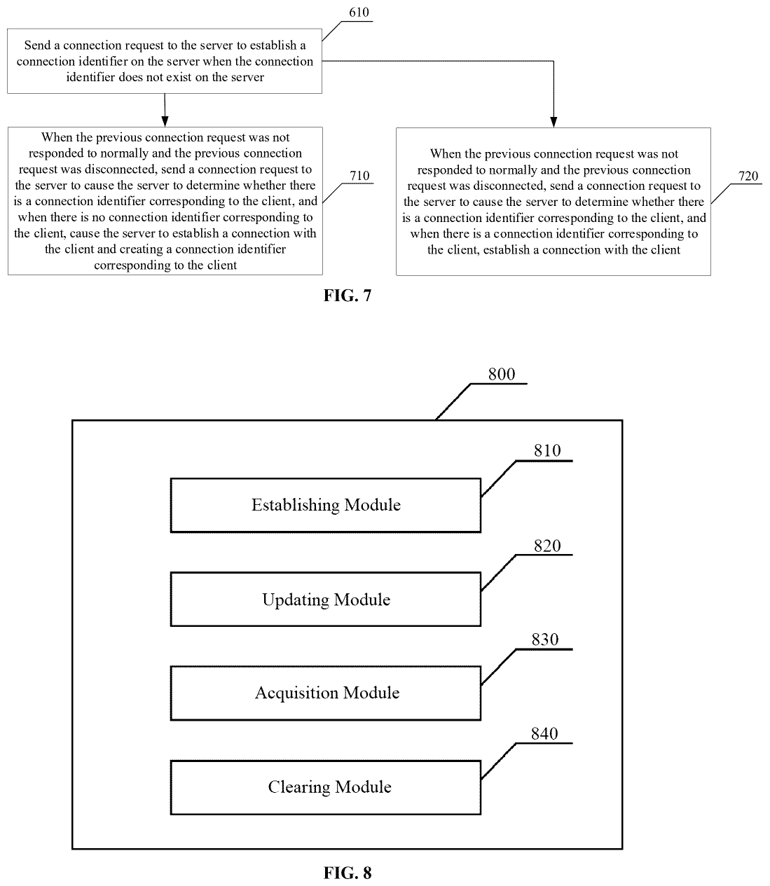

FIG. 6 is a flowchart of the data processing method applied to a client according to some embodiments of the present disclosure.

As shown in FIG. 6, the data processing method applied to the client may include processes 610-630.

610, sending a connection request to the server to establish a connection identifier on the server when the connection identifier does not exist on the server. The server may establish the survival information of the connection identifier and periodically update the survival information based on the survival state of the connection identifier. The survival information can be used to indicate whether the connection identifier is alive.

In the embodiments of the present disclosure, the connection request here may be a first connection request. It should be noted that the first connection request here and the second connection request and the third connection request described below are named only to distinguish the three connection requests, and do not represent the first connection, the second connection and the third connection. The first connection request may be the first connection between the client and the server under normal conditions, or the next connection request after the client and the server have completed normal communication and the connection request has been terminated normally. Based on sending the first connection request, the server may create a connection request corresponding to the client and the file that the client wants to access.

620, when the connection request is not responded to normally and the connection request is disconnected, sending a connection request to the server again to cause the server to obtain the survival information of the connection request to determine whether the connection identifier has timed out, and when the connection identifier times out, causing the server to clear the connection identifier and send a connection failure message to the client.

In the embodiments of the present disclosure, the connection request sent to the server again here is the second connection request. The second connection request is a reconnection request initiated by the client for the same file after the first connection request fails to get a normal response or a failure occurs during the response process of the first connection request, resulting in disconnection. Based on the second reconnection request, the server can look up the survival information of the connection identifier corresponding to the client to determine whether the connection identifier has timed out. When the connection identifier times out, the connection identifier can be cleared and a connection failure message can be sent to the client.

630, sending a connection request to the server again to establish a connection with the client in response to the connection failure message.

In the embodiments of the present disclosure, the connection request sent to the server again here is the third connection request. The third connection request is a reconnection request sent again after receiving the connection failure message generated by the server in response to the second connection request. When the second reconnection request is sent, the timed-out connection identifier has been cleared. Therefore, the process of the third connection request is similar to the first connection request. The client and the server successfully establish a connection, and the client can further access the file to be accessed.

In some embodiments, the client only needs to reconnect three times at most to reconnect to the server, without having to wait for a long time, and the customer experience is good.

FIG. 7 is a flowchart of the data processing method applied to the client according to some embodiments of the present disclosure.

As shown in FIG. 7, based on the data processing method shown in FIG. 6, the data processing method applied to the client may further include processes 710 or 720 after the process at 610.

710, when the previous connection request was not responded to normally and the previous connection request was disconnected, sending a connection request to the server to cause the server to determine whether there is a connection identifier corresponding to the client, and when there is no connection identifier corresponding to the client, causing the server to establish a connection with the client and creating a connection identifier corresponding to the client.

In the embodiments of the present disclosure, the connection request sent to the server here is sent at the same time as the second connection request described in the process at 620. The difference between the two is that the responses received are different. After the connection request is sent here, the response received from the server is that the connection can be made, and the server needs to create a connection identifier after successfully connecting to the client.

720, when the previous connection request was not responded to normally and the previous connection request was disconnected, sending a connection request to the server to cause the server to determine whether there is a connection identifier corresponding to the client, and when there is s connection identifier corresponding to the client and the connection identifier has not timed out, establishing a connection with the client.

In the embodiments of the present disclosure, the connection request sent to the server here is sent at the same time as the second connection request described in the process at 620. The difference between the process at 620 and the process at 710 is that the received response is different. After the connection request is sent here, the server responds that it can connect, and the server does not need to create a connection identifier after successfully connecting to the client.

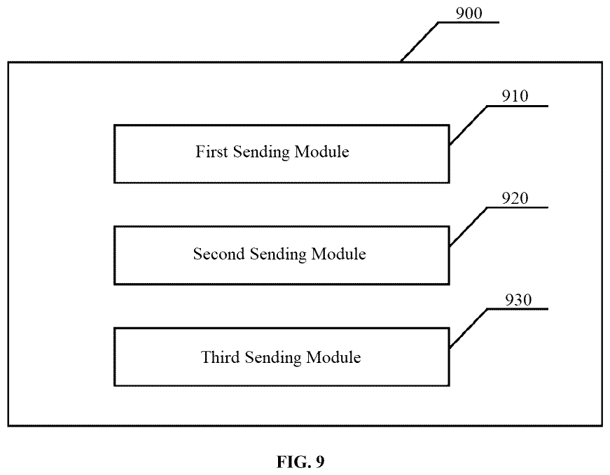

Based on the data processing method described above, the present disclosure also provides a server and a client, which will be described in detail below in conjunction with FIG. 8 and FIG. 9.

FIG. 8 is a schematic structural diagram of a server 800 according to some embodiments of the present disclosure.

As shown in FIG. 8, the server 800 includes an establishing module 810, an updating module 820, an acquisition module 830, and a clearing module 840.

The establishing module 810 may be configured to establish a connection identifier in response to a connection request from a client when there is no connection identifier. In some embodiments, the establishing module 810 may be used to execute the process at 210 described above, which will not be described in detail here.

The updating module 820 may be configured to establish the survival information of the connection identifier and periodically update the survival information based on the survival state of the connection identifier. The survival information may be used to indicate whether the connection identifier is alive. In some embodiments, the updating module 820 may be used to execute the process at 220 described above, which will not be described in detail here.

The acquisition module 830 may be configured to obtain the survival information of the connection identifier to determine whether the connection identifier has timed out in response to the connection request of the client when there is a connection identifier. In some embodiments, the acquisition module 830 may be used to execute the process at 230 described above, which will not be described in detail here.

The clearing module 840 may be configured to clear the connection identifier and send a connection failure message to the client when the connection identifier times out.

In some embodiments, the clearing module 840 may be used to execute the process at 240 described above, which will not be described in detail here.

FIG. 9 is a schematic structural diagram of a client 900 according to some embodiments of the present disclosure.

As shown in FIG. 9, the client 900 includes a first sending module 910, a second sending module 920, and a third sending module 930.

The first sending module 910 may be configured to send a connection request to the server to establish a connection identifier on the server when the connection identifier does not exist in the server. The server may establish the survival information of the connection identifier and periodically update the survival information based on the survival state of the connection identifier. The survival information may be used to indicate whether the connection identifier is alive. In some embodiments, the first sending module 910 may be used to execute the process at 610 described above, which will not be described in detail here.

The second sending module 920 may be configured to send a connection request to the server again when the connection request is not responded to normally and the connection request is disconnected to cause the server to obtain the survival information of the connection identifier to determine whether the connection identifier has timed out. When the connection identifier times out, the server may clear the connection identifier and send a connection failure message to the client. In some embodiments, the second sending module 920 may be used to execute the process at 620 described above, which will not be described in detail here.

The third sending module 930 may be configured to send a connection request to the server again in response to the connection failure message to establish a connection with the client. In some embodiments, the third sending module 930 may be used to execute the process at 630 described above, which will not be described in detail here.

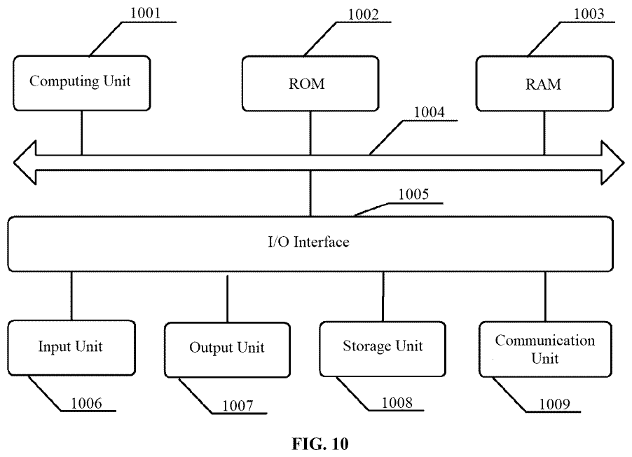

FIG. 10 illustrates a schematic structural diagram of an electronic device 1000 according to some embodiments of the present disclosure. The electronic device can include various forms of digital computers, such as laptops, desktops, workstations, personal digital assistants, servers, blade servers, large computers, and other appropriate computers. The electronic device can also include various forms of mobile devices, such as personal digital processing devices, cell phones, smartphones, wearable apparatuses, and other similar computation devices. In embodiments of the present disclosure, members, connections and relationships of the members, and functions of the members are merely exemplary and are not intended to limit the present disclosure.

For example, the establishing module 810, the updating module 820, the acquisition module 830 and the clearing module 840, or any of the first sending module 910, the second sending module 920 and the third sending module 930 can be combined into one module, or any one of the modules can be split into multiple modules. Alternatively, at least part of the functionality of one or more of these modules can be combined with at least part of the functionality of other modules and implemented into one module. Based on the embodiments of the present disclosure, the establishing module 810, the updating module 820, the acquisition module 830 and the clearing module 840, or at least one of the first sending module 910, the second sending module 920 and the third sending module 930 can be at least partially implemented as a hardware circuit, such as a field programmable gate array (FPGA), a programmable logic array (PLA), a system on a chip, a system on a substrate, a system on a package, an application-specific integrated circuit (ASIC), or any other reasonable manner of integrating or packaging the circuit, such as hardware or firmware, or implemented in any one of the three implementation methods of software, hardware and firmware, or in any appropriate combination thereof. Alternatively, the establishing module 810, the updating module 820, the acquisition module 830 and the clearing module 840, or at least one of the first sending module 910, the second sending module 920 and the third sending module 930 can be at least partially implemented as a computer program module, which, when executed, can perform the corresponding function.

As shown in FIG. 10, the electronic device 1000 includes a computing unit 1001. The computing unit 1001 can be configured to perform various appropriate actions and processes according to the computer program stored in the ROM 1002 or the computer program loaded in the RAM 1003 from the storage unit 1008. In RAM 1003, various programs and data required by the operation of the device 1000 can be stored. The computing unit 1001, ROM 1002, and RAM 1003 can be connected to each other through a bus 1004. An input/output (I/O) interface 1005 is also connected to the bus 1004.

A plurality of members of the device 1000 can be connected to an I/O interface 1005. The plurality of members includes an input unit 1006, such as a keyboard and a mouse, an output unit 1007, such as various types of displays and speakers, a storage unit 1008, such as a magnetic disk and an optical disk, and a communication unit 1009, such as a network card, a modem, a wireless communication transceiver. The communication unit 1009 can be configured to allow the device 1000 to exchange information/data with other apparatuses via a computer network such as the internet and/or various telecommunication networks.

The computing unit 1001 can be various general and/or special purpose processing assemblies with processing and computation capabilities. Some examples of the computing unit 1001 can include, but are not limited to, a central processing unit (CPU), a graphics processing unit (GPU), various dedicated Artificial Intelligence (AI) computation chips, various computation units running machine learning model algorithms, a Digital Signal Processor (DSP), and any appropriate processor, controller, and microcontroller. The computing unit 1001 can be configured to perform the methods and processes described above, such as the application processing method. For example, in some embodiments, the application processing method can be implemented as a computer software program, which is embodied in a computer-readable medium, such as the storage unit 1008. In some embodiments, a part or all of the computer program can be loaded and/or installed onto the device 1000 through a ROM 1002 and/or the communications unit 1009. When the computer program is loaded into a RAM 1003 and executed by computing unit 1001, one or more processes of the application processing method can be performed. In some other embodiments, the computing unit 1001 can be configured to perform the application processing method in any other suitable manner (e.g., through firmware).

Various implementations of the systems and techniques described here above can be implemented in a digital electronic circuit system, an integrated circuit system, a field programmable gate array (FPGA), an application-specific integrated circuit (ASIC), an application-specific standard product (ASSP), a system on a chip (SOC), a complex programmable logic device (CPLD), hardware, firmware, and software of the computer, and/or a combination thereof. The various embodiments can be implemented in one or more computer programs. The one or more computer programs can be performed and/or explained in the programmable system including at least one programmable processor. The programmable processor can include a dedicated or general-purpose programmable processor, which can receive data and instructions from the storage system, at least one input device, and at least one output device, and transmit the data and the instruction to the storage system, the at least one input device, and the at least one output device.

The program codes used to implement the method of the present disclosure can be written in any combination of one or more programming languages. These program codes can be provided to a processor or controller of a general-purpose computer, special-purpose computer, or another programmable data processing device. Thus, when the program codes are executed by the processor or controller, the functions/operations specified in the flowchart and/or the block diagram can be implemented. The program codes can be entirely or partially executed on the machine. The program codes can be executed partially on the machine and partially on a remote machine as an individual software package, or entirely on a remote machine or server.

In the context of the present disclosure, the computer-readable medium can be a tangible medium that includes or stores the program for the instruction execution system, device, or apparatus to use or used in connection with the instruction execution system, device, or apparatus. The computer-readable medium can be a computer-readable signal medium or store a computer-readable storage medium. The computer-readable storage medium can include but is not limited to an electronic, magnetic, optical, electromagnetic, infrared, or semiconductor system, device, or apparatus, or a combination thereof. For example, the computer-readable storage medium can further include an electrical connection based on one or more wires, a portable computer disc, a hard drive, a random-access memory (RAM), a read-only memory (ROM), an erasable programmable read-only memory (EPROM or flash memory), an optical fiber, a compact disc read-only memory (CD-ROM), an optical storage device, a magnetic storage device, or a combination thereof.

To provide interaction with the user, the systems and techniques described here can be implemented on the computer. The computer can include a display device (e.g., a cathode ray tube (CRT) or liquid crystal display (LCD) monitor) configured to display information to the user, and a keyboard and a pointing device (e.g., a mouse or a trackball). The user can provide an input to the computer through the keyboard and the pointing device. Other devices can also be configured to provide interaction with the user. For example, the feedback for the user can be any type of sensory feedback (e.g., visual feedback, auditory feedback, or tactile feedback). The input received from the user can be in any form, including acoustic, speech, or tactile input.

The systems and techniques described here can be implemented in a computation system (e.g., a data server) that includes a back-end member, or a computation system (e.g., an application server) that includes a middleware member, or a computation system (e.g., a personal computer including a graphical user interface or a web browser, the user being able to interact with the system and the technique described here through the graphical user interface or the web browser), or a computation system including a combination of the back-end member, the middleware member, or the front-end member. The members of the system can be interconnected by any form or medium of digital data communication (e.g., a communication network). For example, the communication network can include a local area network (LAN), a wide area network (WAN), and the Internet.

The computer system may include a client terminal and a server. The client terminal and the server can be generally away from each other and typically interact with each other through the communication network. The client-server relationship can be generated by running the client terminal and the server at corresponding computers with the computer programs having the client-server relationship. The server can be a cloud server, also known as a cloud computing server or cloud host. It is a host product in the cloud computing service system. It solves the defects of conventional physical hosts and virtual private server (VPS) services, such as management difficulty and weak business scalability. The server can be a cloud server, a server of a distributed system, or a server combining a blockchain.

The above are merely some embodiments of the present disclosure. The scope of the present disclosure is not limited to this. Those skilled in the art can easily think of variations or replacements within the scope of the present disclosure. These variations or replacements should be within the scope of the present disclosure.

What is claimed is:

1. A data processing method comprising:
establishing a connection identifier in response to a connection request from a client when the connection identifier does not exist;
establishing survival information of the connection identifier, and periodically updating the survival information based on a survival state of the connection identifier, the survival information being used to indicate whether the connection identifier is alive;
when the connection identifier exists, obtaining the survival information of the connection identifier to determine whether the connection identifier has timed out in response to the connection request from the client; and
when the connection identifier times out, clearing the connection identifier and sending a connection failure message to the client.

2. The method of claim 1, wherein periodically updating the survival information based on the survival state of the connection identifier includes:
before the connection request from the client is disconnected due to being successfully responded to, periodically updating the survival information based on the survival state of the connection identifier.

3. The method of claim 1 further comprising:
when the connection request of the client is disconnected due to being successfully responded to, setting a cleanup timer to clear the survival information after a specific time.

4. The method of claim 1 further comprising:
periodically monitoring whether the survival information has timed out; and
when the survival information times out, setting a cleanup timer to clear the timed-out survival information after a specific time.

5. The method of claim 2, wherein obtaining the survival information of the connection identifier to determine whether the connection identifier has timed out includes:
when the survival information of the connection identifier is not successfully obtained, determining that the connection identifier has timed out; or,
when the survival information of the connection identifier is obtained and the survival information is timed out, determining that the connection identifier has timed out.

6. The method of claim 1 further comprising:
when the connection identifier exists, determining whether the connection identifier corresponds to the client in response to the connection request from the client;
when the connection identifier corresponding to the client exists, obtaining the survival information of the connection identifier to determine whether the connection identifier has timed out; and
when the connection identifier has not timed out, establishing the connection with the client.

7. The method of claim 6 further comprising:
when the connection identifier corresponding to the client does not exist in the connection identifiers, establishing the connection with the client and creating the connection identifier.

8. A data processing method, applied to a client, comprising:
sending a connection request to a server to establish a connection identifier on the server when the connection identifier does not exist on the server, the server being configured to establish survival information of the connection identifier and periodically update the survival information based on a survival state of the connection identifier, the survival information being used to indicate whether the connection identifier is alive;
when the connection request is not responded to normally and the connection request is disconnected, sending the connection request to the server again to cause the server to obtain the survival information of the connection identifier to determine whether the connection identifier has timed out, the server being configured to clear the connection identifier and send a connection failure message to the client when the connection identifier times out; and
in response to the connection failure message, sending the connection request to the server again to establish the connection with the client.

9. The method of claim 8 further comprising:
sending the connection request to the server to cause the server to determine whether the connection identifier corresponding to the client exists when a previous connection request is not responded to normally and the previous connection request is disconnected, the server being configured to establish a connection with the client and create the connection identifier corresponding to the client when the connection identifier corresponding to the client does not exist; or,
sending the connection request to the server to cause the server to determine whether the connection identifier corresponding to the client exists when a previous connection request is not responded to normally and the previous connection request is disconnected, the server being configured to establish the connection with the client when the connection identifier corresponding to the client exists and the connection identifier has not timed out.

10. A server comprising computer readable storage medium storing one or more computer instructions and one or more processors, when executed by the one or more processors, the computer instructions implement a data processing method comprising:
establishing a connection identifier in response to a connection request from a client when the connection identifier does not exist;
establishing survival information of the connection identifier, and periodically updating the survival information based on a survival state of the connection identifier, the survival information being used to indicate whether the connection identifier is alive;
when the connection identifier exists, obtaining the survival information of the connection identifier to determine whether the connection identifier has timed out in response to the connection request from the client; and
when the connection identifier times out, clearing the connection identifier and sending a connection failure message to the client.

11. The server of claim 10, wherein periodically updating the survival information based on the survival state of the connection identifier includes:
before the connection request from the client is disconnected due to being successfully responded to, periodically updating the survival information based on the survival state of the connection identifier.

12. The server of claim 10, the method further comprising:
when the connection request of the client is disconnected due to being successfully responded to, setting a cleanup timer to clear the survival information after a specific time.

13. The server of claim 10, the method further comprising:
periodically monitoring whether the survival information has timed out; and
when the survival information times out, setting a cleanup timer to clear the timed-out survival information after a specific time.

14. The server of claim 11, wherein obtaining the survival information of the connection identifier to determine whether the connection identifier has timed out includes:
when the survival information of the connection identifier is not successfully obtained, determining that the connection identifier has timed out; or,
when the survival information of the connection identifier is obtained and the survival information is timed out, determining that the connection identifier has timed out.

15. The server of claim 10, the method further comprising:
when the connection identifier exists, determining whether the connection identifier corresponds to the client in response to the connection request from the client;
when the connection identifier corresponding to the client exists, obtaining the survival information of the connection identifier to determine whether the connection identifier has timed out; and
when the connection identifier has not timed out, establishing the connection with the client.

16. The server of claim 6, the method further comprising:
when the connection identifier corresponding to the client does not exist in the connection identifiers, establishing the connection with the client and creating the connection identifier.
